(19) United States
(12) Patent Application Publication
(10) Pub. No.: US 2006/0165883 A1
(43) Pub. Date: Jul. 27, 2006

(54) Hosiery reinforcing method and apparatus

(76) Inventor: Carolyn Martin, Ferndale, WA (US)

Correspondence Address: HUGHES LAW FIRM, PLLC, PACIFIC MERIDIAN PLAZA, SUITE 302, 4164 MERIDIAN STREET, BELLINGHAM, WA, 98226-5583, US

(21) Appl. No.: 11/336,547

(22) Filed: Jan. 20, 2006

Related U.S. Application Data
(60) Provisional application No. 60/647,354, filed on Jan. 25, 2005.

(51) Int. Cl. B05D 3/00

(52) U.S. Cl. 427/140; 118/255

(57) ABSTRACT

A pantyhose or hosiery reinforcing tool. The tool reinforces the elastic fibers surrounding a tear within the hosiery. The reinforcing tool has a cylindrical containing tube which holds a specific amount of flexible binding solution. The flexible binding solution is in liquid form and is soaked into a porous elastomer material which has a thin wall cell structure to absorb the flexible binding solution. Projecting out of the top of the cylindrical containing tube is an application head which is either cylindrical in shape or hemispherical in shape. The application head is composed of the same porous elastomer material. A top fits over the application head and screws tightly in one form to the cylindrical tube during storage. In application, the application head of the reinforcing tool is pressed against the leading edge of the tear applying the flexible binding solution. The flexible binding dries quickly to reinforce the hosiery elastic fibers.

### RELATED APPLICATIONS

This application claims priority benefit of U.S. Ser. No. 60/647,354 filed Jan. 25, 2005.

### BACKGROUND OF THE INVENTION

a) Field of the Invention

The present embodiment relates to the field of apparel, and or particularly to the class of apparel including panty hose nylon stockings and other items of hosiery. Also, it relates to a device and process for preserving the usable life of hosiery.

b) Background Art

A general description of the use of hosiery, stockings, or nylon type material will be briefly discussed. Stockings, hosiery, or tights, made of nylon and/or spandex, are coverings used by women to fit the body from the waist to the feet.

Hosiery is worn by women for many reasons. The stockings can enhance the curve of the legs through the sheerness, making the legs look smoother. They can also outline shape of the leg through the use of dark colors. The stockings also can provide warmth in colder weather.

Stockings come in a wide range of styles which generally relate to thickness and color. The thinner the stocking the shearer or finer the smoothness of the leg appearance.

Congruent with the thinness, is the likelihood that the stocking will develop rips or tears because of the thin structure of the weave.

The stocking weave is generally composed of nylon fibers and/or spandex fibers. The spandex provides the elasticity, while the nylon provides some elasticity as well as the thinness of the structure. The tearing or running of the stocking is most common with a higher content of nylon and a thinner structure.

The nylon and spandex fibers as stated before have a certain amount of elasticity which corresponds to a certain linear distance the fiber can be stretched without leading to permanent deformation.

When not in use, the nylon and spandex fibers of the hosiery are in a nonelastic state of use. When the user puts on the nylon stockings, the nylon and spandex fibers are stretched to fit the outer circumference of the user's leg. Although the nylon or spandex fibers are still within the elastic range, the cross-sectional area of the stretched fibers has decreased and is more susceptible to failure due to the transverse force as applied by a sharp object of some sort. This transverse force from a sharp object will likely cause a hole in the hosiery, which occurs where one or more of the nylon or spandex fibers has failed causing the elastic tension force within the failed nylon or spandex fibers to be transferred to the surrounding non-failed fibers.

Even though the tear or hole may start in a number of different ways, once it has started it is difficult to prevent the tear from continuing further. To prevent this tearing, there have been a number of solutions provided. One is to use off the shelf nail polish when generally applied at the apex of the tear or at the point where the tear is about to continue will help stop the tear.

The applicator itself may not be configured to apply a uniform and consistent amount of nail polish onto the tear. Also, nail polish takes time to dry. Much of the solution may not adhere to the material because the stocking itself is thin and not very absorbent.

Consequently the application of the nail polish liquid needs to be uniform and consistent, reinforcing the surrounding fiber structures, and if possible, breaching the failed fiber members to provide a patch to enable supplemental transferring of the tension load across the breached portion and also providing additional reinforcement to the surrounding fiber members.

The following patents are related to the problem of fixing or preventing hosiery tears.

U.S. Pat. No. 5,338,784 is directed primarily to the particular composition which is used as the repair liquid. The composition contains nitrocellulose, resin, another ingredient, and also a solvent. In column three (3) beginning on line 7 and following, it states that it could be stored in a jar with a brush, a roll-on bottle, any type of bottle, etc.

U.S. Pat. No. 4,994,127 describes a method of mending runs, snags, holes or the like in hosiery where there is “one-shot application container” containing the liquid adhesive ingredient. It also indicates that decorative material such as dyes, glitter, etc. could be used.

U.S. Pat. No. 5,087,496, shows a self-adhesive device which is attached to the damaged hosiery by Velcro means.

U.S. Pat. No. 4,068,322, discloses an adhesive patch that is placed on either side of the damaged area to prevent further damage.

In addition, a search of the internet uncovered a site that calls itself “PANTYHOSE ENCYCLOPEDIA”, which contains the statement, “The Miracle Against Runs! Just put some nail polish around the run and your pantyhose is saved.” Also, there was uncovered a New York Times publication concerning the care of pantyhose and the five (5) pages of that article are provided in the prior art statement.

### BRIEF DESCRIPTION OF THE DRAWINGS

FIG. 1 is an overall environmental perspective view of the nylon hosiery with a tear;

FIG. 2 is an enlarged view of the hosiery;

FIG. 3 is a plan view of the hosiery and the woven fiber members with a tear;

FIG. 4A is an enlarged view of the nylon fiber members and the forces acting upon them during a tearing situation;

FIG. 4B is an enlarged plan view of the nylon fiber members with the forces normalized;

FIG. 5A is an enlarged plan view of the hosiery tear with a binding solution zone;

FIG. 5B is a cross-sectional view of the stressed fiber members reinforced by the binding composition;

FIG. 6 is a perspective view of a first embodiment;

FIG. 6B is an enlarged perspective view of the user holding a first embodiment and applying the solution to a predetermined circumferential solution zone;

FIG. 6C is an alternative embodiment of the present embodiment's solution application head;

FIG. 6D is an alternative embodiment of the solution applicator head;

FIG. 7 is an alternative perspective view of the solution applicator with a disposable insert.

### DETAILED DESCRIPTION OF THE PREFERRED EMBODIMENTS

In discussing the detailed description of the current embodiment it is preferable to first provide a detailed description of the structure and function of the nylon fabric, thus providing a clear understanding of the current embodiment environment.

With this in mind, a detailed description of the fabric structure and function will be provided, followed by a detailed description of the current embodiment of the hose run stopper method and apparatus which includes the apparatus container or applicator, its application elements, and the binding composition which when applied, reinforces the nylon fabric. Lastly, additional embodiments of the applicator elements will be provided.

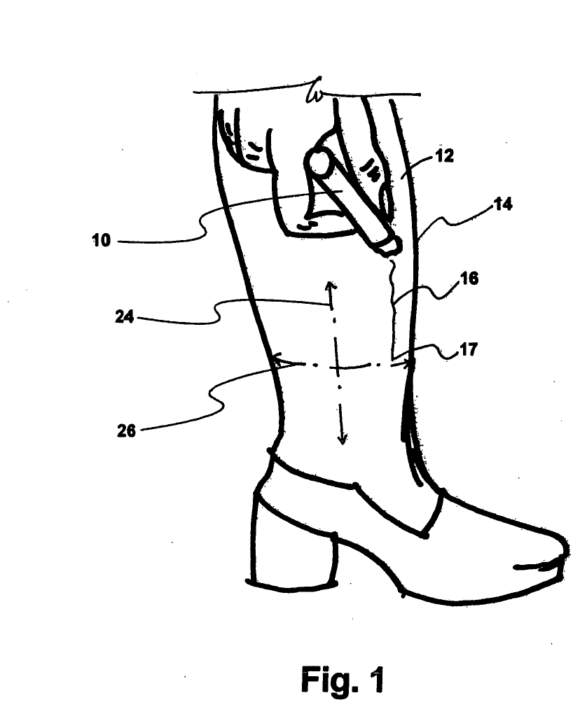

Referring to FIG. 1, the user may be wearing nylon fabric hosiery 14 on her leg 12. Generally, the tear is caused by a snag from a sharp object, which brushes up against the user's leg 12. Stopping a tear in the hosiery is difficult given the specific mechanics and structure of the typical nylon hosiery.

Although the run or tear 16 caused by the snag on the object may be unnoticeable because of the relatively fine weave of the hosiery 14, once the balanced structure has been disturbed, a tear 16 will quickly develop, and for reasons discussed below, the tear may irreparably harm the hosiery 14, making it unusable.

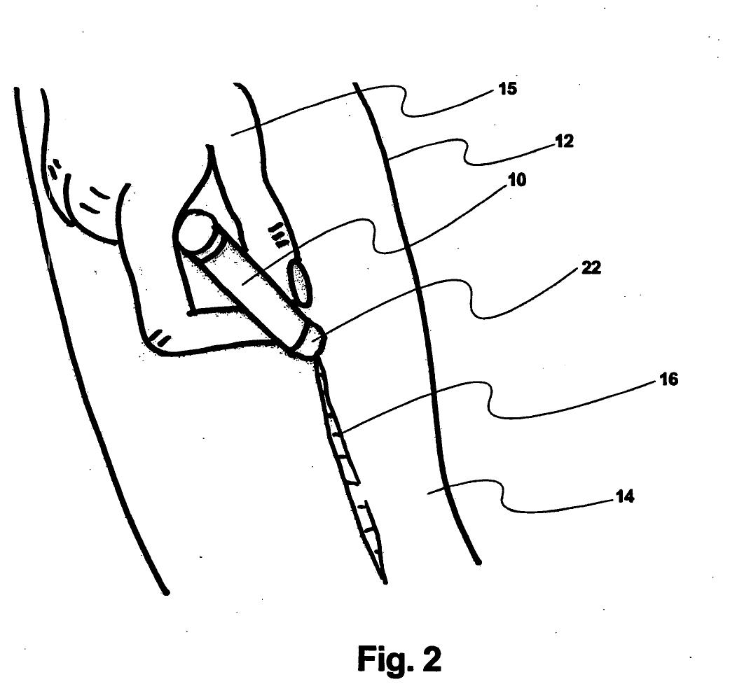

Still referring to FIG. 1, the typical nylon stocking 14 is worn on the leg 12, the leg having a longitudinal axis 24 and a circumferential axis 26. The fibers of the nylon stocking 14 run in both the longitudinal axial direction 24 and the circumferential axial direction 26. Referring to FIG. 2, a magnified version of the tear 16 is shown within the hosiery 14, where the user is applying the current embodiment as discussed below.

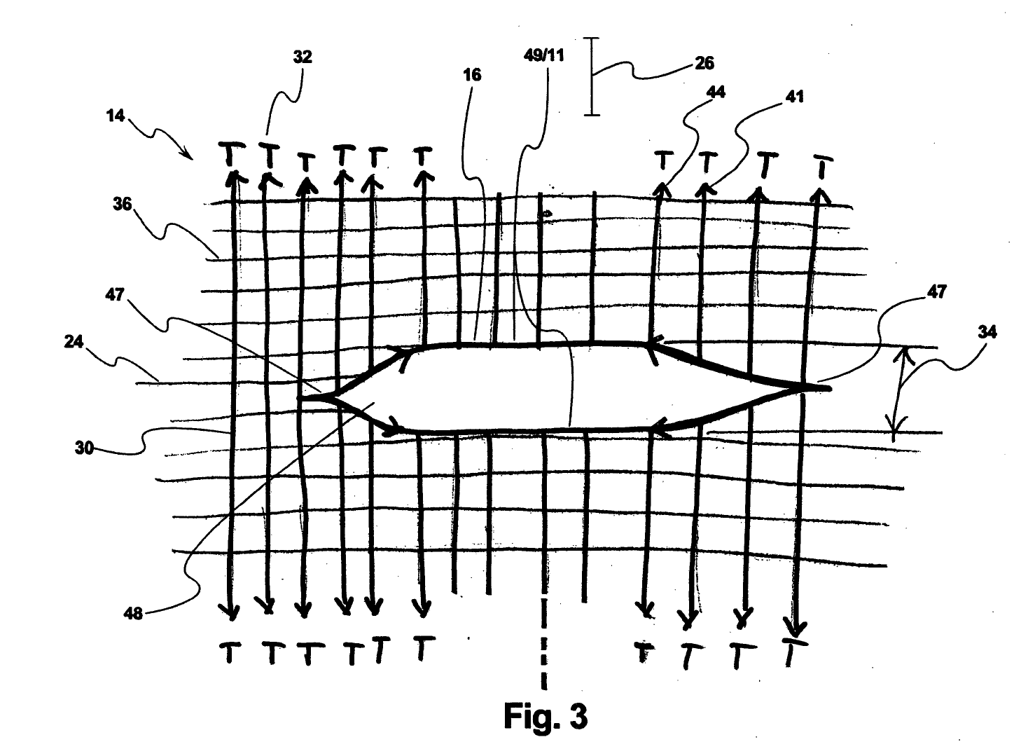

The weave of the stocking will now be discussed. Referring to FIG. 3, the nylon stocking fiber members are shown equally spaced along the longitudinal axis 24, as well as the circumferential axis 26 of the user's leg. Further, the nylon stocking fibers are shown in tension, or in other words are shown after the user has put the hosiery stockings 14 on and have been stretched around the circumference of the user's leg. The nylon fabric has a series of longitudinal fiber members 36 as well as a series of generally perpendicular to the longitudinal plane, circumferential fiber members 30. During normal wear, the circumferential fiber members are stretched around the outer surface area of the user's appendage or leg 12 a specific distance or circumferential stretch distance 34 which is dependent upon the user's leg size. Directly proportional to the circumferential stretch distance 34 is the amount of elastic tension force 32 applied to the individual circumferential fiber members 30. The longitudinal fiber members 36 are also tensioned along the longitudinal length of the user's leg.

After the snag has occurred, and still referring to FIG. 3, the nylon hosiery 14 will, develop a rip or tear 16. Once the hole is created, the tensioned circumferential fiber members 30 act to pull the tear 16 further apart. This force creates the run. As mentioned before, the tear 16 is proportional in size to the circumferential stretch distance 34. After the elastic circumferential tension force 32 has pulled the longitudinal fiber members 36 to the proximate circumferential stretch distance 34, the circumferential fiber members 30, are in an untensioned resting state or in other words are untensioned fiber members 44.

The tear 16 has parallel longitudinal border fiber members 49 as well as two apex points 47 at the beginning and end of the tear 16. It is at the apex point 47 where the elastic tension force 32 residing in the circumferential fiber members 30 pulls the connected longitudinal fiber members 36 apart and continues the tear 16.

Now describing in particular the tearing or ripping action. As the longitudinal fiber members 36 are pulled away from their existing longitudinal location towards the parallel longitudinal border fiber members 49, the circumferential fiber members 30 are transitioning from the tension state to the untensioned state and act on this longitudinal fiber member 36 to create a resultant angular tension member 42 pulling on the individual circumferential fiber members 30 at the apex point 47 of the tear 16.

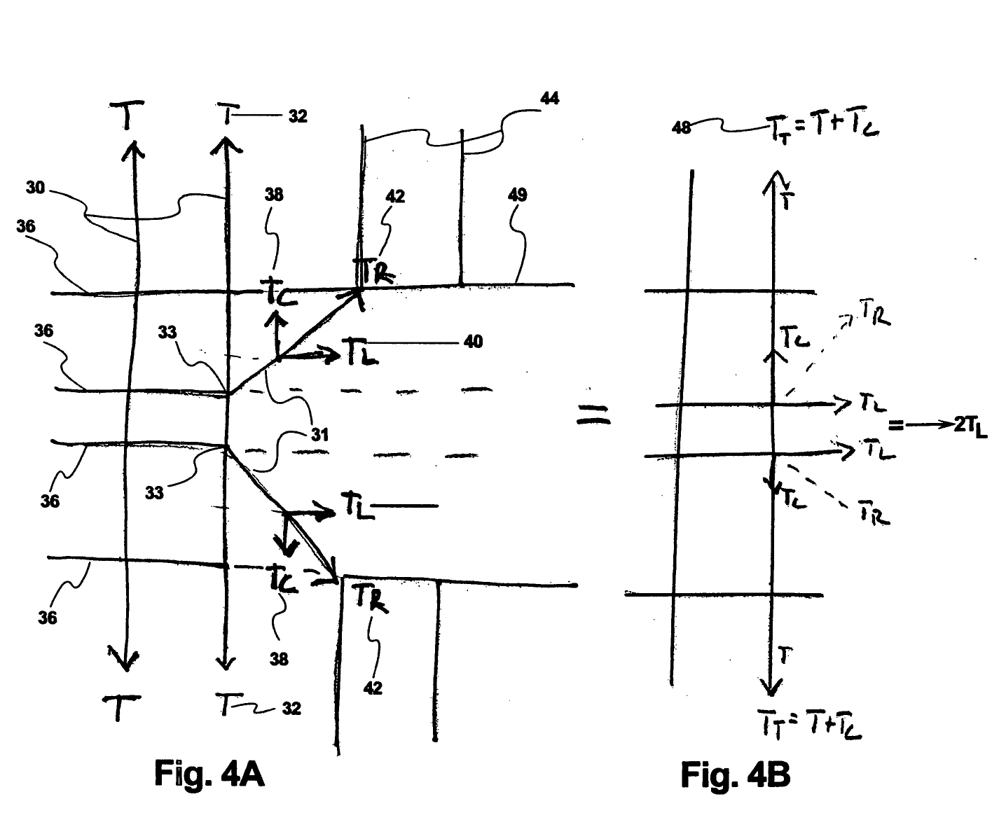

Referring to FIG. 4A, a simplified version of this action is shown with a single circumferential fiber member 30 having an existing elastic tension force 32 applied. Also on the upper longitudinal portion of the stocking, the longitudinal fiber members 36 are shown running longitudinally. At the lower longitudinal portion of the stocking below the circumferential fiber members 30 are two longitudinal fiber members 31 being pulled towards the longitudinal border fiber member position 49. Along the axis of these transitioning longitudinal fiber members 31 is a resultant angular tension force 42.

This resultant tension force 42 has a longitudinal tension component 40 and circumferential tension component 38. For calculation purposes, we will assume that the circumferential tension component 38 is one half of the tension force 32, while the longitudinal tension component 40 is some other force amount which results in combination with the circumferential tension component 38 to produce the resultant angular tension force 42 as shown.

The origin 33 of this resultant angular tension force 42 is the intersection, or connection of the longitudinal fiber members 36 and the circumferential fiber member 30. Simplifying the force diagram, and referring to FIG. 4B, the circumferential tension component 38 can be combined with the original circumferential tension force 32 in both the positive and negative axial circumferential directions to provide a total circumferential tension force 48. This total circumferential tension force 48 acts to further stress the immediate circumferential fiber member 30, reducing its cross-sectional area, and concurrently reducing its capacity to resist shear stresses. Combined with the two longitudinal tension component's 40 acting cross-sectionally at the origin 33, the circumferential fiber member 30 tends to fail. Therefore the same resultant tension force 42 is applied to the next circumferential fiber member 30 in the longitudinal direction, creating a chain reaction of fiber member failures.

This series of chain reaction failures of the fiber members can occur gradually or nearly instantaneously, depending on the size of the user's leg as well as the flexing of the user's muscle, thus increasing the circumferential distance and increasing the circumferential tension force, stressing the fibers beyond their elastic range.

Therefore, it is desirable to have a solution or composition contained within an applicator, which when the solution is applied to the tear 16, binds to the fiber members, reinforcing them at the weakened stress point, as well as drying or binding quickly to the fiber members.

Also, it is highly likely that the user is wearing the hosiery to work or at a social function, and needs an applicator which can provide accuracy of the application of the binding solution to the tear, as well as convenience in use.

Therefore the discussion of the current embodiment acting in the above described nylon hosiery environment will first describe the elements of the applicator, followed by the elements of a typical binding solution, and lastly, additional embodiments of the applicator will be discussed.

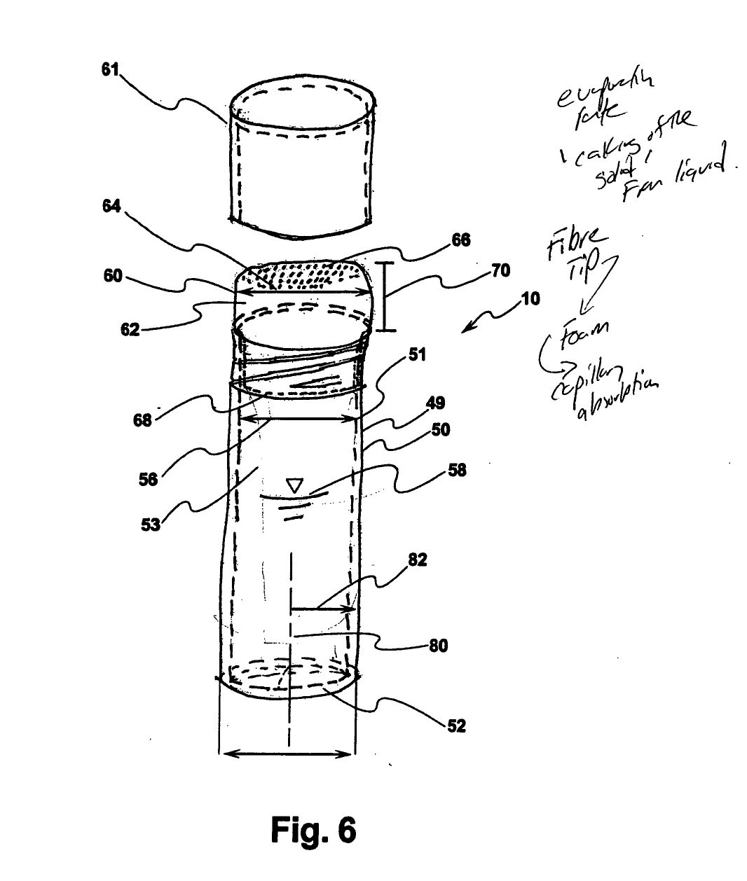

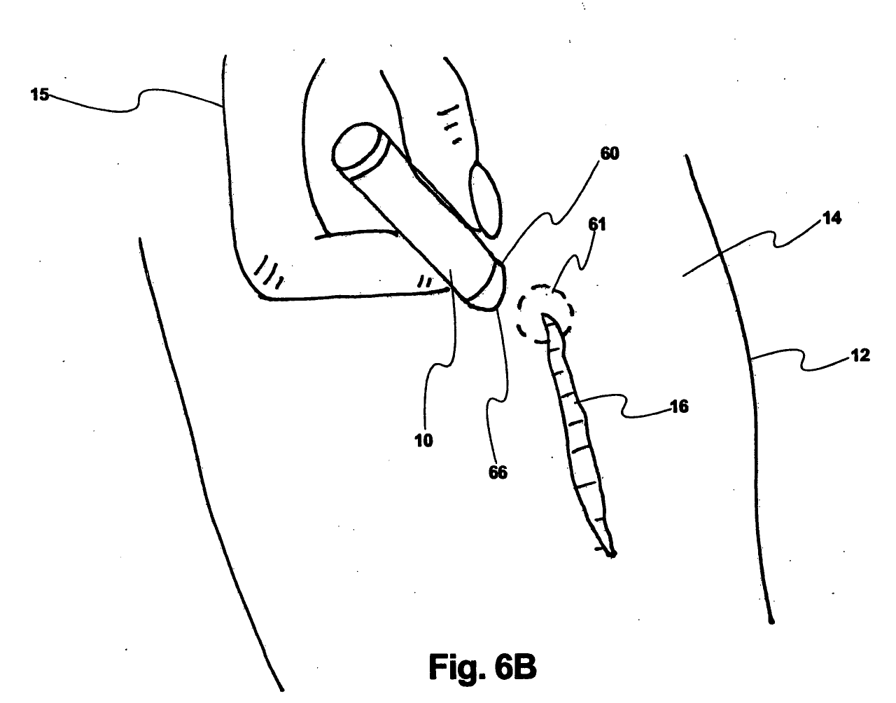

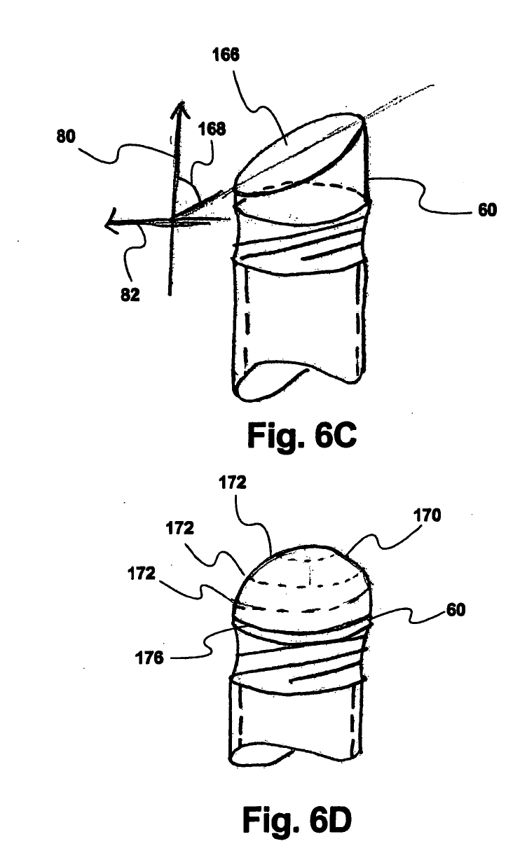

The solution applicator 10, as referred to in FIG. 6, is configured to provide ease of handling as well as portability. In this current embodiment, the solution applicator 10 is shown as a generally cylindrical tube with a top and bottom as well as an inner region and an application tip. The application tip is covered by a cap. Although this embodiment shows a cylindrical configuration, other ergonomically designed configurations to easily fit within the user's hand are could be used. These other ergonomically designed configurations can include an elliptical configuration, a rectangular configuration, or a series of configurations designed to fit within the palm of the hand. Such configurations could also include an oval type applicator with two parallel walls and a perimeter sidewall connecting the two parallel walls, but for current discussion purposes the cylindrical shell will be discussed.

Still referring to FIG. 6, the solution applicator 10 is shown in this embodiment, with a cylindrical shell 50 holding the binding solution 58. The cylindrical shell is arranged along a vertical axis 80 and a radial axis 82. In the vertical direction, the cylindrical shell 50 has a height in the existing embodiment of 3 ½ inches; other lengths can be provided, such as a shell having a longer vertical length of 5 inches, and a lesser radial dimension. The cylindrical shell has an inner surface 51, and an outer surface 49. At the base of the cylindrical shell 50 is a bottom wall 52 which seals off the inner region 53 of the cylindrical shell 50.

At the top portion of the solution applicator 10 is an application head 60 which is fashioned in the current embodiment, from a porous or sponge like material. In the current embodiment, the sponge like material is a commercially available material with a porous cellular structure large enough to carry the solution and be sufficiently compressible to discharge the solution. This sponge like material is well-known in the art and is used commercially in many different applications. Use of the sponge like material allows the binding solution 58 contained within the solution applicator 10 to migrate up through the application head 60 and be absorbed into the cells of the material for application.

Still referring to FIG. 6, various shapes of the application head 60 can be provided for accurate application of the binding solution 58 to the fiber material 14 as discussed in the alternative embodiments below. The application head 60 in the current embodiment is fashioned in a cylindrical shape having an outer cylindrical surface 62 as well as a top application surface 66 and a bottom absorbing surface 68. The top application surface 66 is within the horizontal radial plane 82 of the solution applicator 10. By having a flat top application surface 66, the user can apply a uniform amount of binding solution 58 to the hosiery 14 within a predefined circumferential solution zone 61 as seen in FIG. 6B. In this current embodiment the outer diameter of the cylindrical shell is approximately¼ of an inch, and the outer diameter of the application head is also approximately¼ of an inch. The application head has a vertical height of approximately⅜ of an inch, and has a general configuration of a cylindrical shape similar to that of the solution applicator.

By using the flat top application surface 66, the user a more uniform application which could compromise the effectiveness of the applicator. In contrast, a user could use an edge of the application head to be more specific in the application of the solution to the nylon tear.

A sealed environment to keep the solution in the containing region from escaping is desirable. Referring back to FIG. 6, the outer diameter 64 of the application head 60 is at least the same size as the cylindrical shell inner diameter 56. The bottom portion of the application head 60 is placed down into the top portion of the cylindrical shell 50. This creates a tightly sealed environment where the binding solution 50 cannot escape the inner chamber region 53 of the solution applicator 10 without first passing through the porous elastomer material. The porous elastomer material of the application head 60 acts as a sponge to absorb a predetermined amount of binding solution 58. This absorption occurs in one form by capillary action.

For reasons discussed below, the binding solution has an alcohol-based content, and will readily evaporate. Therefore, to keep the absorbed binding solution 58 from evaporating and thus binding within the porous elastomer material 60, a closure cap 62 is provided to create a hermetically sealed environment thus preventing the binding solution from evaporating out of the cylindrical shell inner region 53.

An additional embodiment of this solution applicator 10 is that the inner region 53 of the cylindrical shell 50 is nearly 100% hermetically sealed from the outside environment when the cap 61 is attached over the application head. When initially used, the inner region 53 is completely full of binding solution 58. After a period of time, there becomes a void or air space within the inner region 53 due to the consumption or use of the solution.

Thus, the binding solution 58 contained within the inner region 53 will not take up the entire volume of the inner region 53, thus leaving a volume space for potential evaporation. A vapor volume region 61 will develop, and become filled with a combination of air and evaporating binding solution vapor. This combination of air and binding solution vapor will act to mitigate any hardening of the binding solution 58 on or in the cellular structure of the sponge like material as well as within the cylindrical shell 50 itself. Similarly, when the solution applicator cap 62 is on the solution applicator 10, virtually no airspace is left between the cap top 65 and the top application surface 66. What little airspace there is left will be filled with a mixture of oxygen and binding solution vapor, and the evaporation rate of the binding solution from the top application surface 66 will balance out to nearly zero, thus keeping the application head 60 moist with the binding solution 58.

In this particular embodiment, the cylindrical cap 62 has a height substantially great enough to cover the application head 60 and be secured to the outer wall of the cylindrical shell 49 through one of many securing means. One such securing means is a screw type cap with grooves fabricated into the cylindrical shell outer wall 49 and corresponding grooves inside the cylindrical cap 62.

A brief discussion of the application process of the binding solution 50 to the hosiery 14 will now be provided.

Referring to FIG. 6B, the solution applicator 10 holding the binding solution is shown in its pre-application state where the user has positioned the applicator head 60 just above a tear 16 in the hosiery 14.

Still referring to FIG. 6B, the user presses the solution applicator 10 against the hosiery tear 48 and depending upon the amount of binding solution 58 desired to cover the rip zone 48 as well as the surrounding fiber members, the user will apply either a greater or lesser compression force downward on the solution applicator 10 thus creating a surface engagement between the top applicator surface 66 and the hosiery or nylon stockings 14. The corresponding compression of the sponge application head 60 reduces the containing volume 70 and forces the binding solution 58 onto the hosiery 14.

After the application process has been performed, the binding solution 58 will harden around the individual fiber members adjacent to the tear zone and reinforce the fiber members within the path of the tearing chain reaction to resist the additional tension and shear forces.

A detailed description of the fiber members as reinforced by the binding solution will now be provided.

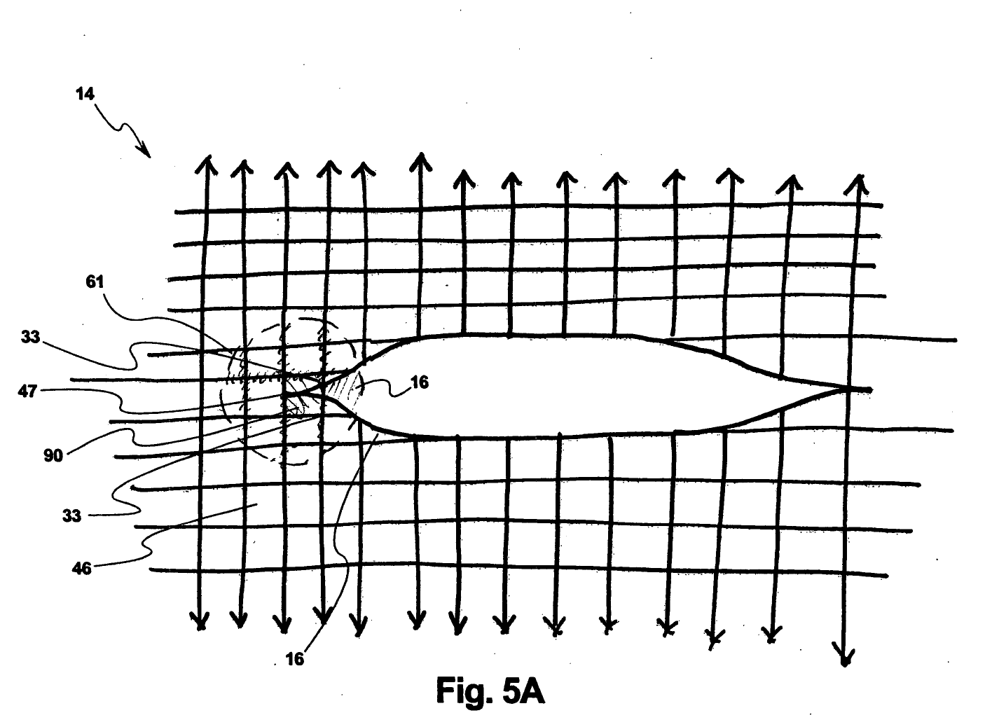

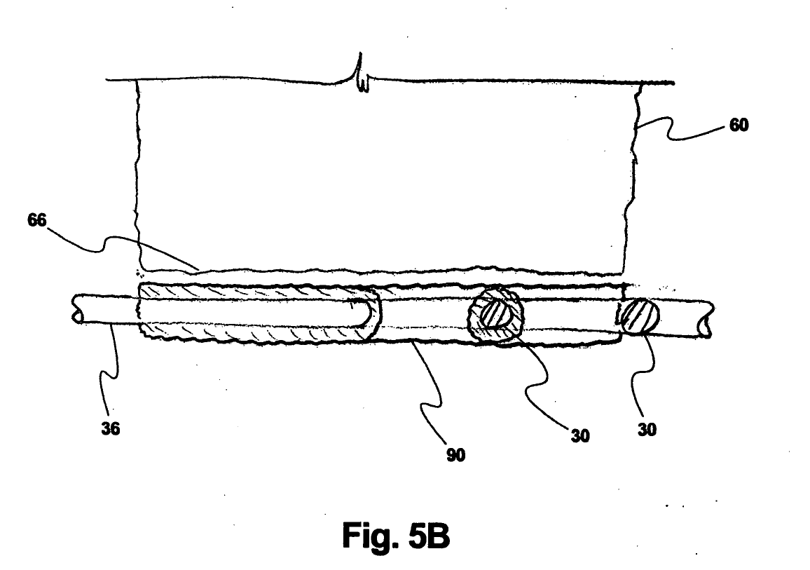

Referring to FIGS. 5A and 5B, one embodiment of the binding solution zone 61 is shown. The binding solution 58 as applied to the nylon stocking 14 at the apex 47 of the tear 16 has a circumferential outer boundary line which is the outer limits of the applied binding solution 58. After a period of time, the binding solution 58 evaporates to form a binding composition 90. In a first form, the flexible binding composition only surrounds and reinforces the circumferential fiber members 30 and the longitudinal fiber members 36. This binding composition 90 may in a second form fill the fiber cells 46 in addition to surrounding the circumferential fiber members 30 and the longitudinal fiber members 36. In such a form, the binding composition 90 can also span between the parallel longitudinal border fiber members 49 of the tear 16, thus reestablishing the circumferential tension capacity of the broken circumferential fiber members 30.

Referring to FIG. 5B, the circumferential fiber members 30 as well as the longitudinal fiber members 36 are shown in cross-section with the binding composition 90 applied and surrounding the tensioned members 30 and 36. Because of the additional tension, the fiber members 36 have a reduced cross-sectional area. The binding composition 90 surrounding the tensioned members 30 and 36, adds additional tensile capacity to the individual circumferential fiber members 30, as well as distributes the tension force to the surrounding circumferential fiber members 30 and longitudinal fiber members 36. Further, the origin 33, FIG. 5A, is also reinforced substantially in both the longitudinal and circumferential direction's by the binding solution 58. Thus, when the resultant angular tension force 42, FIG. 4A, is applied to the origin point 33, the reinforced members adequately resist potential failure.

By using a uniform top application surface 66 during application of the binding solution, the user can be assured a uniform amount of solution is applied to all of the surrounding fiber members, thus providing uniform reinforcement and distribution of the load around the apex 47 of the tear 16.

A detailed description of the binding solution 58 will now be provided. The binding solution 58 should have characteristics which include elasticity for stretching along with the nylon fiber members, binding properties to attach to the nylon fibers, and a high rate of evaporation so as to minimize wait time. The physical characteristics of the binding solution 58 can be composed of a natural resin which dries to a hard but flexible and durable compound after application. This compound can easily bind with the fibers in a nylon or spandex and nylon hosiery stocking.

The current embodiment of the binding solution 58 is comprised of four parts of a commercially available nail polish compound and one part of a thinning solvent. In this embodiment, the four parts nail polish compound has the following chemical composition by percentage of weight.

| 4 parts Nail Polish | Nail Polish Compound % |
|---|---|
| Compound | Composition by Weight |
| Nitrocellulose | 12.5% |
| Toluene-sulfonamide- | 10% |
| formaldehyde resin | |
| Camphor | 3% |
| Dibutyl phthalate | 5% |
| ethlyl acetate | 25% |
| butyl acetate | 23.5% |
| toluene | 20% |
| titanium dioxide | 0.5% |
| amaranth | 0.5% |
| total | 100% |

Additionally, in this embodiment the one part thinning solvent has the following chemical composition by percentage of weight.

| | Thinning Solvent % Composition |
|---|---|
| 1 part Thining Solvent | by Weight |
| Nitrocellulose | 0% |
| Toluene-sulfonamide- | 0% |
| formaldehyde resin | |
| Camphor | 0% |
| Dibutyl phthalate | 0% |
| ethyl acetate | 70.6% |
| butyl acetate | 0% |
| toluene | 0% |
| titanium dioxide | 0% |
| amaranth | 0% |
| ethyl alcohol | 17.4% |
| water | 12% |
| total | 100% |

Lastly, in combination the binding solution 58 from four parts Nail Polish compound, and one part thinning solvent, has the following chemical composition by percentage of weight.

| Flexible Bindinq Compound | % Composition by Weight |
|---|---|
| Nitrocellulose | 10% |
| Toluene-sulfonamide- | 8% |
| formaldehyde resin | |
| Camphor | 2.4% |
| Dibutyl phthalate | 4% |
| ethlyl acetate | 34.12% |
| butyl acetate | 18.8% |
| toluene | 16% |
| titanium dioxide | 0.4% |
| amaranth | 0.4% |
| ethyl alcohol | 3.48% |
| water | 2.4% |
| total | 100% |

For reasons discussed above the application of this binding solution to the nylon stockings 14 around the tear 16 from the snag as shown in FIG. 2 prevents the nylon stockings 14 from being ruined.

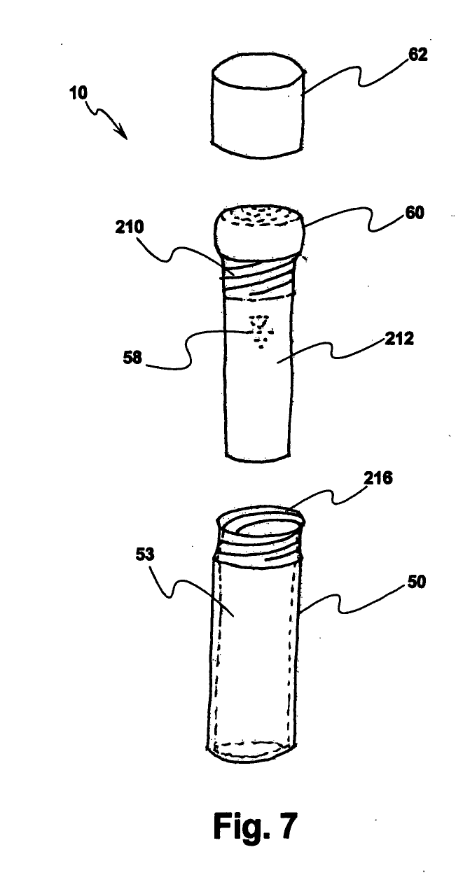

A discussion of alternative embodiment of the application head 60 will now be provided in FIGS. 6C and 6D and a discussion of an alternative configuration of the solution applicator 10 will be discussed in FIG. 7.

Referring to FIG. 6C, in an alternative embodiment, the porous elastomer material application head 60 has a uniform angular application plane 166, where the application plane 166 is cut at an angle 168 from the radial axis plane 82 to allow for customization of the application process of the application head 60 to the nylon stockings 14. Depending on the desired configuration of the application head 60, the uniform angular application plane 166 could be manufactured from an angle 168 ranging from 0° to 90° from the radial axis plane 82.

Additionally, in another alternative embodiment, referring to FIG. 6D, the application head 60 is shown configured in a semi-spherical shape 170. This semi spherical shape 170 enables the user to apply increasing amounts of binding solution 58 within ever-increasing amounts of application zones 172, congruent with the amount of downward force being applied by the user to the solution applicator 10. As the force increases, the elastomeric semi-spherical application head 60 is further depressed, thus covering a greater area and discharging more binding solution 58.

Thus, if the tear 16, FIG. 6B, is relatively minor, the user may choose to apply a minimal amount of the binding solution 58 by dabbing the hosiery tear 16 with the semi-spherical application tip 174. If the tear 48 is large or is under large tension stresses, the user may choose to apply a greater amount of the binding solution 58 by pressing the porous elastomer application head 60 firmly onto the hosiery 14. Thus, the semi-spherical application shape 170 provides the user one option in applying varying amounts of the binding solution 58 the hosiery tear 48.

Referring to FIG. 7, in an alternative embodiment, the solution applicator 10 is provided with a disposable insert section 200 which allows the user to refill the solution applicator 10 with a new recharged binding solution section. The disposable insert section 200, in the alternative embodiment, has the application head 60 as well as male threads 210 and contains the binding solution 58 within the solution containment region 212. The solution containment region 212 is configured cylindrically to fit within the cylindrical shell 50 of the solution applicator 10. The cylindrical shell 50 of the solution applicator 10 has female insert inner threads 216 which correspond to the male threads 210 of the disposable insert 200. After the user disposes of the used insert, she can installed the recharged disposable binding solution insert 200 and then secure the cap 62 over the application head 60 to hermetically seal the solution applicator 10. Additionally, the disposable insert 200 can have varying application head configurations, as discussed previously.

Therefore I claim:

1. An application apparatus adapted to reinforce hosiery, said hosiery comprised of lateral and circumferential interwoven fibers, said fibers having an elastic range, said hosiery having a region of fibers stressed beyond their elastic range, said application apparatus comprising:
a. a containing section adapted to contain a flexible binding solution, said flexible binding solution adapted to reinforce said fibers;
b. an application medium configured to receive a first volume of said flexible binding solution, contain a second volume of said flexible binding solution, and dispense a third volume of said flexible binding solution;
c. said application medium further configured to dispense said third volume of flexible binding solution onto a hosiery reinforcing region located on said hosiery;
d. whereby said application medium receiving said first volume of flexible binding solution, containing said second volume of flexible binding solution, and dispensing said third volume of flexible binding solution onto said hosiery reinforcing region located on said hosiery, reinforces said fibers of said hosiery to resist stressing of said hosiery fibers beyond their elastic range.

2. The application apparatus according to claim 1 wherein said containing section further comprises a lower containing region and an upper containing region, said lower containing region holding said flexible binding solution in a substantially liquid phase, said upper containing region holding said flexible binding solution in a substantially vapor phase.

3. The application apparatus according to claim 2 wherein said containing section further comprises said lower containing region substantially configured as a cylindrical shell, said lower containing region having a bottom wall and perimeter side walls with a top port configured to accept said application medium.

4. The application apparatus according to claim 3 wherein said containing section further comprises said upper containing region substantially configured as a cylindrical cap shell and adapted to cover said application medium and connect to said lower containing region.

5. The application apparatus according to claim 1 wherein said application medium comprises: a porous elastomer material, said porous elastomer material comprising a cell structure to absorb and release said flexible binding solution in a liquid phase.

6. The application apparatus according to claim 3 wherein said application medium further comprises: a lower receiving portion configured to receive said first volume of flexible binding solution; a medial portion configured to contain said second volume of flexible binding solution; an upper dispensing portion configured to dispense said third volume of flexible binding solution.

7. The application apparatus according to claim 6 wherein said application medium further comprises: said lower receiving portion contained within said lower containing region; said medial portion partially contained within said lower containing region and extending vertically upwards out of said lower containing region into said upper containing region; said upper dispensing portion contained within said upper containing region.

8. The application apparatus according to claim 6 wherein said upper dispensing portion further comprises: a hemispherical shape.

9. The application apparatus according to claim 6 wherein said upper dispensing portion further comprises: a conical shape.

10. The application apparatus according to claim 6 wherein said upper dispensing portion further comprises a cylindrical volume, said cylindrical volume comprising a cylindrical outer surface and a circular top surface.

11. The application apparatus according to claim 10 wherein said circular top surface is aligned with a horizontal plane.

12. The application apparatus according to claim 10 wherein said circular top surface is angularly aligned between a horizontal plane and a vertical plane.

13. The application apparatus according to claim 1 wherein said flexible binding solution comprises four parts nail polish compound and one part thinning solvent.

14. The application apparatus according to claim 13 wherein said four parts nail polish compound further comprises the following nail polish compounds in percent composition by weight:

| | | |
|---|---|---|
| nitrocellulose | 12.5%; | |
| toluene-sulfonamide- | 10%; | |
| formaldehyde resin | | |
| camphor | 3%; | |
| dibutyl phthalate | 5%; | |
| ethlyl acetate | 25%; | |
| butyl acetate | 23.5%; | |
| toluene | 20%; | |
| titanium dioxide | 0.5%; | and |
| amaranth | 0.5%. | |

15. The apparatus according to claim 13 wherein said one part thinning solvent further comprises the following thinning solvent compounds in percent composition by weight:

| | | |
|---|---|---|
| ethyl acetate | 70.6%; | |
| ethyl alcohol | 17.4%; | and |
| water | 12%. | |

16. The application apparatus according to claim 1 wherein said flexible binding solution comprises the following compounds in percent composition by weight:

| | | |
|---|---|---|
| nitrocellulose | 10%; | |
| toluene-sulfonamide- | 8%; | |
| formaldehyde resin | | |
| camphor | 2.4%; | |
| dibutyl phthalate | 4%; | |
| ethlyl acetate | 34.12%; | |
| butyl acetate | 18.8%; | |
| toluene | 16%; | |
| titanium dioxide | 0.4%; | |
| amaranth | 0.4%; | |
| ethyl alcohol | 3.48%; | and |
| water | 2.4%. | |

17. The application apparatus according to claim 1 wherein said hosiery reinforcing region further comprises all lateral and circumferential interwoven fibers adjacent to said region of fibers stressed beyond their elastic range.

18. The application apparatus according to claim 1 wherein said region of fibers stressed beyond their elastic range includes a first longitudinally aligned apex and a second longitudinally aligned apex, said hosiery reinforcing region further comprising: a first set of fibers adjacent to said first longitudinally aligned apex; a second set of fibers adjacent to said second longitudinally aligned apex.

19. An application apparatus adapted to reinforce hosiery, said hosiery comprised of lateral and circumferential interwoven fibers, said fibers having an elastic range, said hosiery having a region of fibers stressed beyond their elastic range, said application apparatus comprising:
a. a containing section comprising a lower containing region and an upper containing region;
b. a flexible binding solution comprising four parts nail polish compound and one part thinning solvent;
c. an application medium comprising a porous elastomer material, said porous elastomer material comprising a cell structure to absorb and release said flexible binding solution;
d. said application medium further comprising a lower receiving portion configured two receive a first volume of flexible binding solution; a medial portion configured to contain a second volume of flexible binding solution; an upper dispensing portion configured to dispense a third volume of flexible binding solution;
e. whereby said application medium receiving said first volume of flexible binding solution, containing said second volume of flexible binding solution, and dispensing said third volume of flexible binding solution onto said hosiery reinforcing region located on said hosiery, reinforces said fibers of said hosiery to resist stressing of said hosiery fibers beyond their elastic range.

20. A process to reinforce hosiery, said hosiery comprised of lateral and circumferential interwoven fibers, said fibers having in elastic range, said hosiery having a region of fibers stressed beyond their elastic range, said process comprising:
a. applying a flexible binding solution to the region of fibers stressed beyond their elastic range by:
i. compressing an application medium comprising a third volume of flexible binding solution against said region of fibers stressed beyond their elastic range; said application medium further comprising a second volume of contained flexible binding solution and a first volume of received flexible binding solution;
ii. decompressing said application medium from said region of fibers stressed beyond their elastic range;
b. recharging said third volume of flexible binding solution into said application medium by:
i. absorbing from a containing section holding said flexible binding solution into said application medium having a first volume of received flexible binding solution;
ii. retaining said flexible binding solution in said application medium as a second volume of contained flexible binding solution;
c. reapplying said flexible binding solution to an unreinforced region of fibers stressed beyond their elastic range.

21. The process to reinforce hosiery according to claim 20 wherein said process further comprises:
a. covering said application medium with an upper containing section;
b. connecting said upper containing section to said containing section;
c. whereby covering said application medium prevents said flexible binding solution from evaporation.
